(19) United States
(12) Patent Application Publication
(10) Pub. No.: US 2023/0417365 A1
(43) Pub. Date: Dec. 28, 2023

(54) MEMBER AND METHOD FOR MANUFACTURING HIGH-PRESSURE TANK LINER

(71) Applicant: HONDA MOTOR CO., LTD., Tokyo (JP)

(72) Inventors: Takaharu SATO, Tokyo (JP); Yuka KISHI, Wako-shi (JP)

(21) Appl. No.: 18/341,095

(22) Filed: Jun. 26, 2023

(30) Foreign Application Priority Data
Jun. 27, 2022 (JP) 2022-102775

(51) Int. Cl. F17C 1/04

(52) U.S. Cl. CPC F17C 1/04; F17C 2201/0109; F17C 2203/0604; F17C 2205/0397; F17C 2209/221; F17C 2209/232

(57) ABSTRACT

A member for manufacturing a high-pressure tank liner is provided for producing a high-pressure tank liner with better welding quality between its liner halves than conventional products. The high-pressure tank liner is produced by welding together a pair of liner halves that have cylindrical bodies to be connected with each other on each joint portion having an opening at its one end. The member includes: the liner half; and a cap member that is easily attached to and removed from a communication tube of the liner half, which communication tube is formed on another end opposite to the joint portion between the liner halves and causes an inside and an outside of the high-pressure tank liner to communicate with each other.

### CROSS REFERENCE TO RELATED APPLICATIONS

The present invention relates to and asserts priority from Japanese patent application No. 2022-102775 filed on Jun. 27, 2022, and incorporates entirety of the contents and subject matter of all the above application herein by reference.

### TECHNICAL FIELD

The present invention relates to a member for manufacturing a high-pressure tank liner and a method for manufacturing a high-pressure tank liner.

### BACKGROUND ART

Conventionally, so-called high-pressure tanks for filling high-pressure gas is known as having a fiber-reinforced resin layer formed on an outside of a liner (high-pressure tank liner) made of thermoplastic resin (see, for example, PTL 1). This type of liner is manufactured by welding together a pair of bottomed cylindrical liner halves each having a bottom. Specifically, a liner half has a communication tube at one end and a circular opening at the other end, which tube communicates an inside and outside of the liner. The liner is manufactured by heating and melting end surfaces forming the circular openings of the liner halves to weld the liner halves together.

### CITATION LIST

### Patent Literature

### [PTL 1]

International Publication No. WO/2019/131737

### SUMMARY OF INVENTION

### Technical Problem

However, with the conventional liner manufacturing device (see, for example, PTL 1), it is difficult to heat and melt the end surface forming the circular opening of the liner half uniformly along its circumferential line, resulting in irregular melting on the end surface of the liner half. Therefore, the conventional liner manufacturing device might cause a risk of an insufficient quality of welding between the liner halves.

An object of the present invention is to provide a member and a method for manufacturing a high-pressure tank liner with better welding quality between liner halves than conventional liners.

### Solution to Problem

The present invention that solves the aforementioned problem provides a member for manufacturing a high-pressure tank liner that is produced by welding together a pair of liner halves having cylindrical bodies on their one ends having openings to connect them, each of the members including the liner half and a cap member that is easily attached to and removed from a communication tube of the liner half that is formed on another end opposite to a joint that is the one end between the liner halves and communicates an inside and an outside of the high-pressure tank liner.

Further, the method for manufacturing the high-pressure tank liner is characterized to include: preparing the pair of members for manufacturing the high-pressure tank liner; heating and melting each of end surfaces having the openings of the pair of members for manufacturing the high-pressure tank liner with a preset heating source, which members are placed to face each other at each of the openings of the liner halves; and welding together the end surfaces of the liner halves melted with each other to form the high-pressure tank liner.

### BRIEF DESCRIPTION OF DRAWINGS

FIG. 1 is a longitudinal sectional view of a high-pressure tank using a high-pressure tank liner obtained by a manufacturing method according to an embodiment of the present invention.

FIG. 2 is an illustration of a configuration of a device for manufacturing a high-pressure tank liner according to the embodiment of the present invention.

FIG. 3 is a partially enlarged cross-sectional view of section III in FIG. 2.

FIG. 4 is a partially enlarged cross-sectional view of section IV in FIG. 2.

FIG. 5 is an illustration of a welding step between members for manufacturing a high-pressure tank liner in a method of manufacturing a high-pressure tank liner according to the embodiment of the present invention.

FIG. 6 is an illustration of a cutting step in the method for manufacturing the high-pressure tank liner according to the embodiment of the present invention.

FIG. 7A is a schematic diagram showing a movement of an airflow when an end of the member for manufacturing the high-pressure tank liner is heated in the method for manufacturing the high-pressure tank liner according to the embodiment of the present invention.

FIG. 7B is a partially enlarged cross-sectional view of VIIb section of FIG. 7A.

FIG. 7C is a schematic diagram showing a melting state of the end of the member for manufacturing the high-pressure tank liner in the VIIb section of FIG. 7A.

FIG. 8A is a schematic diagram showing a movement of an airflow when the end of the liner half is heated in a manufacturing method according to a comparative example.

FIG. 8B is a partially enlarged cross-sectional view of the VIIIb section of FIG. 8A.

FIG. 8C is a schematic diagram showing a molten state of the end of the liner half in the VIIIb section of FIG. 8A.

FIG. 8D is a partially enlarged cross-sectional view of the VIIId section of FIG. 8A.

FIG. 8E is a schematic diagram showing the molten state of the end of the liner half in the VIIIb section of FIG. 8A.

FIG. 9 is an illustration of a configuration of the member for manufacturing the high-pressure tank liner for according to a modification of the present invention.

### DESCRIPTION OF EMBODIMENTS

Next, a detailed description is given of an embodiment of implementing the present invention referring to the drawings as appropriate.

First, a description is given of a high-pressure tank using high-pressure tank liners obtained by a manufacturing method according to the embodiment of the present invention

### <<High-Pressure Tank>>

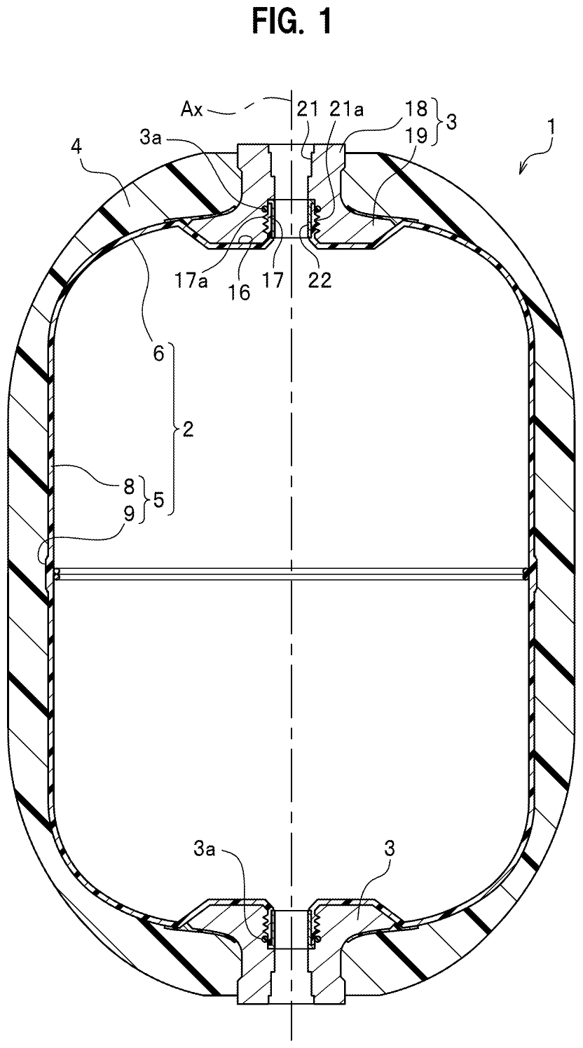

FIG. 1 is a longitudinal sectional view of a high-pressure tank 1 using a high-pressure tank liner 2 (hereinbelow, sometimes referred as “liner 2”) obtained by the manufacturing method according to the embodiment of the present invention.

The high-pressure tank 1 is supposed, for example, to be installed in a fuel cell vehicle to store hydrogen gas supplied for a fuel cell system. However, the high-pressure tank 1 is not limited to this usage and may be used for high-pressure gas for other applications.

As shown in FIG. 1, the high-pressure tank 1 includes a liner 2, which is described in detail below, a mouthpiece 3 connected to the liner 2, and a fiber-reinforced resin layer 4 covering an outside of the liner 2 and the mouthpiece 3 over a span from the liner 2 to the mouthpiece 3.

The mouthpiece 3 is assumed to be formed of a metallic material such as, for example, aluminum alloy. The mouthpiece 3 includes a cylindrical mouth body 18 having inside a fill and drain hole 21, and a flange 19 formed at one end of the mouth body 18 in axial directions. The fill and drain hole 21 is connected to an inside of the high-pressure tank 1 at the one end of the mouth body 18 where the flange 19 is formed. A pipe (omitted in the figures), which is to be connected to the aforementioned fuel cell system or the like, is connected to the other end of the fill and drain hole 21.

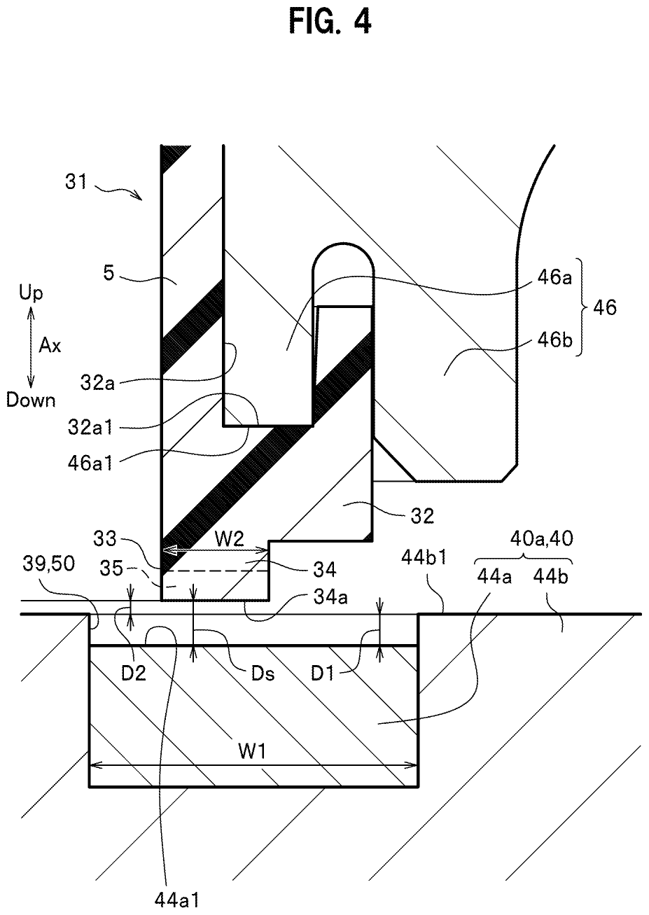

On an inner circumferential surface of the fill and drain hole 21 at the one end of the mouth body 18, a threaded portion 21a is formed to engage with a threaded portion 17a formed in a communication tube 17 of the liner 2, which is described below. An O-ring 3a is attached between a tip of the communication tube 17 of liner 2 and the inner circumferential surface of the fill and drain hole 21. Note that the O-ring 3a corresponds to a “seal member” as defined in CLAIMS. As explained below, an O-ring contact surface 17b (see FIG. 4) is formed on an outer circumferential surface of the communication tube 17. Note that this O-ring contact surface 17b corresponds to a “seal member contact surface” as defined in the CLAIMS.

The fill and drain hole 21 has in its inside a cylindrical collar 22 made of metallic material disposed. This collar 22 extends from one end supported by the inner circumferential surface of the fill and drain hole 21 toward the liner 2 to be fitted into the communication tube 17 of the liner 2.

The fiber-reinforced resin layer 4 in the present embodiment is assumed to be obtained by winding a prepreg, in which the reinforcing fibers are pre-impregnated with a matrix resin, around the outer circumferential surfaces of the liner 2 and the mouthpiece 3, and then curing this matrix resin.

The reinforcing fiber in the present embodiment is assumed to be a strip like roving (omitted in the figures) that is formed by further bundling together a plurality of strands each formed of a plurality of carbon fiber filaments. Note that the reinforcing fibers are not limited to the above material, and for example, aramid fiber, boron fiber, alumina fiber, silicon carbide fiber, and the like may also be used.

The matrix resin in the present embodiment is assumed to be made of cured thermosetting resin, such as epoxy resin, phenol resin, unsaturated polyester resin, polyimide resin, and the like.

Note that a method of forming the fiber-reinforced resin layer 4 is not limited to a method using the prepreg described above. Thus, the fiber-reinforced resin layer 4 may be made, for example, by impregnating matrix resin into reinforcing fibers that is resin-unimpregnated and wound around the liner 2 and then curing the reinforcing fibers.

### <<High-Pressure Tank Liner>>

Next, description is given of the liner 2 (see FIG. 1) obtained by the manufacturing method according to the present embodiment.

The liner 2 is a hollow body made of thermoplastic resin. Thermoplastic resin includes, but are not limited to, polyamide resin, polyethylene resin, and the like.

The liner 2 according to the present embodiment includes a body part 5 made of a cylindrical body and a mirror part 6 that is integrally molded at each end of the body part 5.

The body part 5 includes a major portion 8 that is formed with a predetermined outer diameter and occupies most of the body part 5 along the axis Ax, and a diameter-expanded portion 9 that is formed in a center along the axis Ax of the body part 5 and has a larger diameter than the major portion 8.

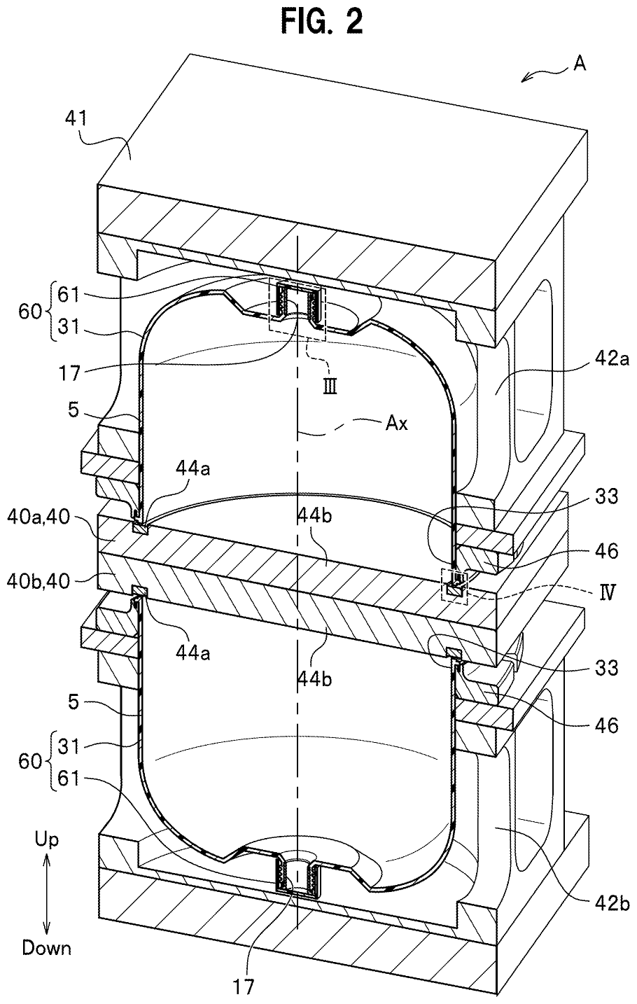

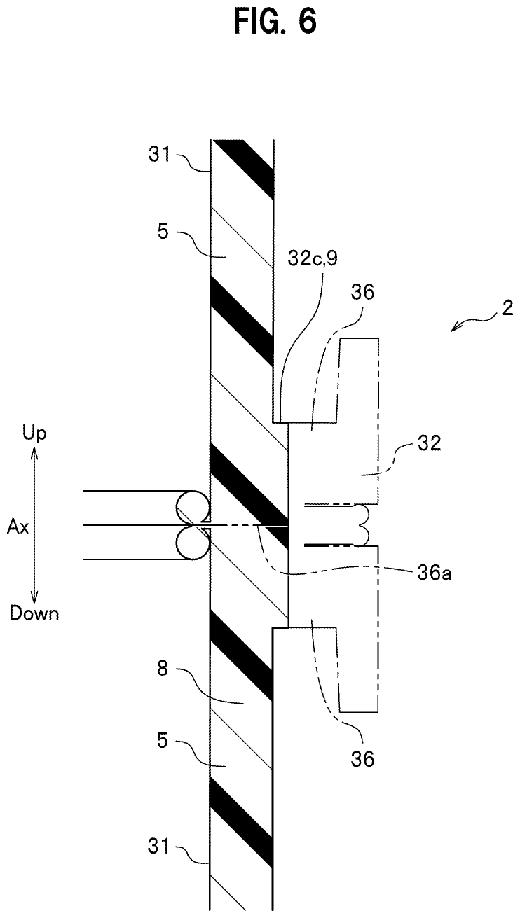

The diameter-expanded portion 9 is formed by cutting a joint 36 (see FIG. 6) that is formed by connecting the ends of the liner halves 31 (see FIG. 2) by welding, as explained in detail below.

As shown in FIG. 1, the mirror part 6 is flattened-bowl shaped to converge in a manner of gradually shrinking in diameter as going away from the body part 5 to outward along the axis Ax.

The radially central portion of the mirror part 6 is provided with a recess portion 16 that is recessed to match a shape of the flange 19 of the mouthpiece 3.

A center of the recess portion 16 is provided with the aforementioned communication tube 17 formed to protrude toward an inside of the fill and drain hole 21 of the mouthpiece 3, which communication tube 17 communicates an inside and outside of the liner 2.

The threaded portion 17a that engages with the threaded portion 21a of the fill and drain hole 21 described above is formed on an outer circumferential surface of the communication tube 17.

### <<Member for Manufacturing High-Pressure Tank Liner>>

Next, a member for manufacturing a high-pressure tank liner is described.

This member for manufacturing a high-pressure tank liner is a member that is placed in a manufacturing device A (see FIG. 2) for manufacturing the liner 2 (see FIG. 1).

FIG. 2 is an illustration of a configuration of the manufacturing device A. FIG. 2 is a longitudinal cross-sectional view of the manufacturing device A. Members of the manufacturing device A are partially shown for drawing convenience.

The manufacturing device A is configured to weld together a pair of members 60 for manufacturing a high-pressure tank liner (hereinafter simply referred to as “liner manufacturing member 60”) to form a single unit.

The liner manufacturing member 60 is configured to have a cap member 61 attached to the communication tube 17 of the liner half 31, as shown in FIG. 2. Specifically, the cap member 61 is removably attached to the communication tube 17 formed opposite to the opening 33 of the liner half 31 of the liner manufacturing member 60.

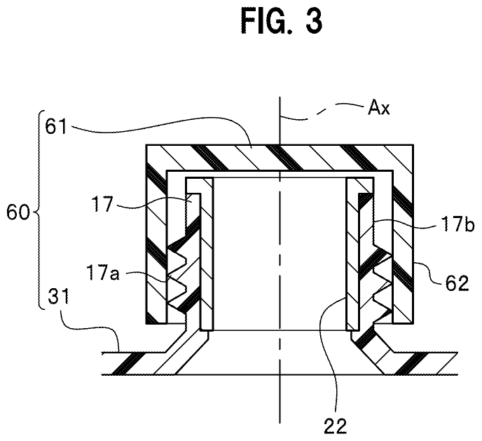

FIG. 3 is a partially enlarged cross-sectional view of the section III in FIG. 2.

As shown in FIG. 3, the cap member 61 in the present embodiment is assumed to be a bottomed cylindrical body that is externally fitted to the outer circumferential surface of the cylindrical communication tube 17.

The cap member 61 is attached to the communication tube 17 to restrain a flow of air that tends to pass from inside to outside or from outside to inside of the liner half 31 (see FIG. 2) during the heating process of the manufacturing method of liner 2 (see FIG. 1), which is explained in detail below.

The O-ring contact surface 17b (seal member contact surface) shown in FIG. 3 contacts with the O-ring 3a (see FIG. 1) as a seal member when the liners 2 form the high-pressure tank 1 (see FIG. 1). A peripheral wall 62 of the cap member 61 attached to the communication tube 17 covers the O-ring contact surface 17b of the communication tube 17, thereby preventing the O-ring contact surface 17b from being damaged or dirty. Further, the peripheral wall 62 covers the threaded portion 17a of the communication tube 17 to prevent the threaded portion 17a from being damaged or dirty. This means that the peripheral wall 62 of the cap member 61 corresponds to a “protective part” as defined in CLAIMS.

The cap member 61 is attached to the communication tube 17 having the collar 22 attached thereto as shown in FIG. 3, but may also be attached to the communication tube 17 without the collar 22.

The cap member 61 in the present embodiment is assumed to be made of elastic material such as synthetic rubber or elastic porous material such as sponge to be held onto the communication tube 17 by a contracting force. Further, the cap member 61 is capable of releasing an internal pressure of the united liner halves 31 when the internal pressure increases in the welding step of the manufacturing method of the liner 2 (see FIG. 1), which is explained in detail below. Specifically, the cap member 61 is capable of releasing the pressure through a screwed groove of the threaded portion 17a when the internal pressure of the liner halves 31 increases. Further, the cap member 61 is made of the porous material and therefore is capable of releasing the pressure through its continuous microporous portions.

However, note that the material of the cap member 61 is not limited to the above materials.

Next description is given of the liner half 31. The liner half 31 is substantially the same in its shape as that when the liner 2 shown in FIG. 1 is divided in two at a center of the axis Ax, except that the liner half 31 has a flange 32 (see FIG. 4) and a protruding end 34 (see FIG. 4), which are described below.

FIG. 4 is a partially enlarged cross-sectional view of the section IV in FIG. 2, showing a bottom end of the liner half 31 that is placed on an upper position of a pair of upper and lower liner halves 31 (see FIG. 2).

As shown in FIG. 4, the opening 33 of the liner half 31 is provided with a flange 32 and the protruding end 34 having a melting allowance 35, which is explained in detail below.

The flange 32 is an annulus that is coaxial with and integrally molded into the body part 5 to extend radially outward (the right direction on the sheet of FIG. 4) from the body part 5 of the liner half 31.

The flange 32 has a circumferential groove 32a formed thereon.

This circumferential groove 32a extends along a circumference of the flange 32 so as to open upward.

A bottom surface 32a1 of the circumferential groove 32a is formed with a flat surface and is parallel to an end surface 34a of the protruding end 34 that is also formed with a flat surface similarly to the bottom surface 32a1.

The protruding end 34 is an annulus that is coaxial with the body part 5 that is integrally molded onto an end surface of the opening 33 of the liner half 31, as shown in FIG. 4.

An outer diameter of the protruding end 34 is configured to be larger than the outer diameter of the body part 5 of the liner half 31 and smaller than the outer diameter of the flange 32.

Further, an inner diameter of the protruding end 34 is set as the same as the inner diameter of the liner half 31.

Furthermore, a thickness of the protruding end 34 along the axis Ax of the liner half 31 is thicker than the melting allowance 35 for welding together the liner halves 31 as described below.

The above description with reference to FIG. 4 is given of the upper liner half 31 between the pair of the upper and lower liner halves 31 (see FIG. 2), but the detailed description of the lower liner half 31 is omitted because it has a vertically symmetrical structure with the upper liner half 31.

### <<Device for Manufacturing High-Pressure Tank Liner>>

Next, a manufacturing device for the liner 2 (see FIG. 1) is described.

Returning to FIG. 2, the manufacturing device A is configured to weld together the liner halves 31 of the pair of the liner manufacturing members 60 to form a single unit.

The manufacturing device A at which the liner manufacturing members 60 are arranged includes mainly a casing 41 placed on a grounding surface such as the ground, an upper support 42a supporting the liner half 31 of the upper liner manufacturing member 60 of the pair of the liner manufacturing members 60 at an upper part of the casing 41 via a support jig 46; a lower support 42b supporting the liner half 31 of the lower liner manufacturing member 60 at a lower part of the casing 41 via a support jig 46; and a heater 40 for heating and melting ends of the liner halves 31 of the respective liner manufacturing members 60.

A lower end of the upper support 42a has a support jig 46 attached thereto to support the liner half 31 with the opening 33 facing downward of the liner manufacturing member 60.

An upper end of the lower support 42b has a support jig 46 attached thereto to support the liner half 31 with the opening 33 facing upward of the liner manufacturing member 60.

Each of the upper and lower pair of the support jigs 46 is arranged to engage the flange 32 (see FIG. 4) of the liner half 31 and to contact the outer circumferential surface of the body part 5 (see FIG. 4) of the liner half 31. This causes the support jigs 46 to make the liner half 31 supported by each of the upper support 42a and the lower support 42b.

The support jig 46 has an inner claw 46a and an outer claw 46b that engage the flange 32, as shown in FIG. 4.

The inner claw 46a contacts the outer circumferential surface of the body part 5 of the liner half 31 and is fitted into the peripheral groove 32a of the flange 32.

A tip surface 46a1 of the inner claw 46a is formed with a flat surface and is parallel to the bottom surface 32a1 of the peripheral groove 32a.

The outer claw 46b is disposed outside from the outer circumference of the inner claw 46a and contacts with the outer circumferential surface of the flange 32. Specifically, the outer claw 46b clamps a radially outer wall of the circumferential groove 32a of the flange 32 with the inner claw 46a fitted into the circumferential groove 32a.

The lower support jig 46 shown in FIG. 2 is arranged to have a vertically symmetrical structure with respect to the upper support jig 46 shown in FIG. 4. Therefore, a detailed explanation of this lower support jig 46 is omitted.

Next is a description of the heater 40 (see FIG. 2) that constitutes a part of the manufacturing device A (see FIG. 2).

As shown in FIG. 2, the manufacturing device A is equipped with a heater 40a for heating the liner half 31 located on the upper position and a heater 40b for heating the liner half 31 located on the lower position. Note that the heaters 40a and 40b are simply referred to as “heater 40” when it is not necessary to distinguish them.

As shown in FIG. 2, the heater 40 in the present embodiment includes a base member 44b that is made of a plate with a rectangular planar shape and a heating source 44a that is embedded in the base member 44b in a ring shape.

As shown in FIG. 4, a surface 44a1 of the heating source 44a is recessed toward a back side of the base member 44b (figure omitted) more than a surface 44b1 of the base member 44b.

In other words, the surface 44a1 of the heating source 44a is set within a recess 39 that is recessed from the surface 44b1 of the base member 44b.

However, the surface 44a1 of the heating source 44a can be flush with the surface 44b1 of the base member 44b, as described below.

The surface 44a1 of the heating source 44a is flat over the circumferential and radial direction of the ring shape and parallel to the surface 44b1 of the base member 44b.

The step (distance) between the surface 44b1 of the base member 44b and the surface 44a1 of the heating source 44a is represented by the depth of the recess 39, indicated by a sign D1 in FIG. 4.

The heating source 44a in the present embodiment is assumed to be, but not limited to, one that uses Joule heat from an electric heating wire or the like, or one that uses radiant heat from far-infrared radiation.

The heating source 44a in the present embodiment is positioned opposite the end surface 34a of the protruding end 34 of the liner half 31, as shown in FIG. 4.

The surface 44a1 of the heating source 44a is positioned so that it is parallel to the end surface 34a of the protruding end 34.

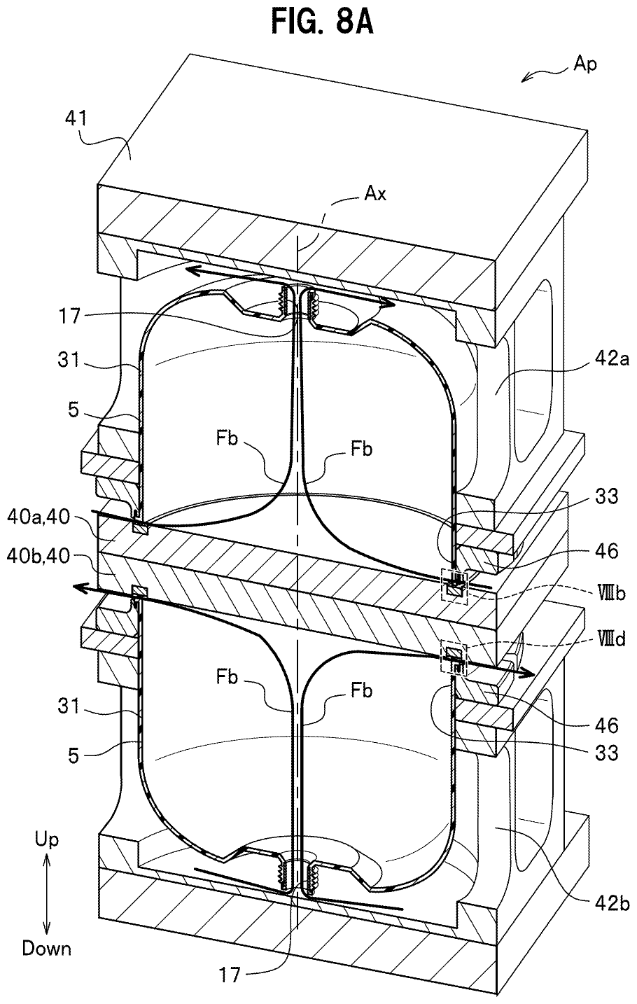

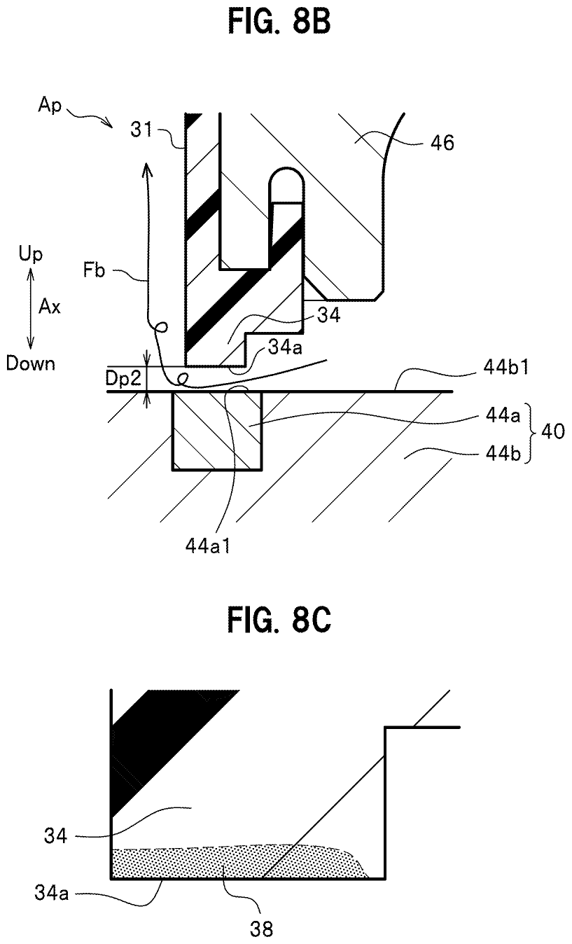

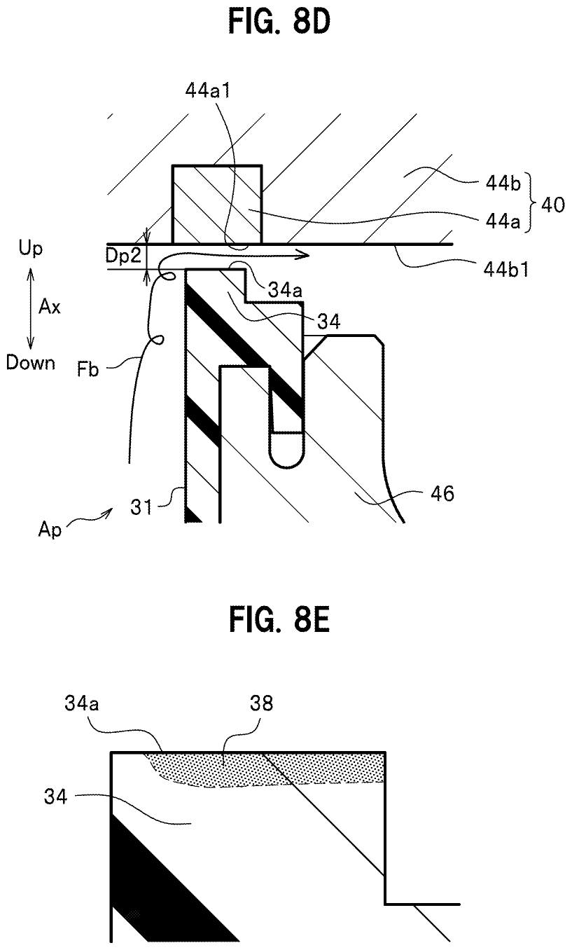

A distance D2 from the end surface 34a of the protruding end 34 to the surface 44b1 of the base member 44b is shorter than a distance Dp2 (see FIG. 8B) of the conventional manufacturing device Ap (see FIG. 8B) described below, due to a step of depth D1 between the surface 44a1 of the heating source 44a and the surface 44b1 of the base member 44b

The distance D2 satisfies the following equation (1), where a distance of the surface 44a1 from the heating source 44a to the end surface 34a of the protruding end 34 is indicated by a sign Ds, which is a design criterion.

[Math. 1]

D2=Ds−D1 (1)

The distance Ds as the design criterion is a value that is set in advance assuming that the surface 44b1 of the base member 44b and the surface 44a1 of the heating source 44a are flush. This distance Ds as the design criterion may be set by a well-known method that takes into account of conditions such as, for example, an output capacity of the heater 40 (heating source 44a), a material character of the liner half 31, a radial width of the end surface 34a, and the like.

To give an example, the distance Ds as the design criterion can be set at 0.3 to 2 mm, under the following conditions: a temperature of the heating source 44a: 500 to 700° C., a material of the liner half 31: polyamide resin, radial width of the end surface 34a: 3 to 5 mm, and the depth D1 from the surface 44a1 of the heating source 44a to the surface 44b1 of the base member 44b: 3.5 to 5 mm. However, the distance Ds is not limited to this example.

Preferably, the ring-shaped radial width W1 of the heating source 44a in the present embodiment is assumed to be set to be at least 3 times the radial width W2 of the protruding end 34 of the liner half 31. And the width W1 of the heating source 44a is preferably larger than the radial width W2 of the protruding end 34 of the liner half 31 by 5 mm or more in the inward and out ward radial directions respectively.

An outer diameter of the heating source 44a is preferably at least 5 mm larger than the outer diameter of the protruding end 34 of the liner half 31, and more preferably larger than the outer diameter of the flange 32 of the liner half 31.

### <<Manufacturing Method of High-Pressure Tank>>

Next, the manufacturing method of the liner 2 according to the present embodiment is described.

The present manufacturing method includes the following steps: heating the protruding ends 34 (see FIG. 4) of the liner halves 31 (see FIG. 2) included in the pair of liner manufacturing members 60 that are prepared in advance; welding together the liner halves 31 (see FIG. 2); and cutting a joint between the liner halves 31 (see FIG. 2) that are integrated by the welding.

### <Heating Liner Halves>

In the heating, a pair of the liner manufacturing members 60 (see FIG. 2) are prepared.

The liner half 31 included in the liner manufacturing member 60 in the present embodiment is assumed to be obtained by an injection molding or blow molding using thermoplastic resin.

The cap member 61 (see FIG. 3) included in the liner manufacturing member 60 in the present embodiment is assumed to be obtained by a compression molding using synthetic rubber.

The liner manufacturing member 60 of the present embodiment is formed by attaching the cap member 61 to the communication tube 17 of the liner half 31.

In the heating step, as shown in FIG. 2, the heater 40 is placed between the liner halves 31 of the liner manufacturing members 60.

As shown in FIG. 4, the surface 44a1 of the heating source 44a of the heater 40a (a surface facing the end surface 34a of the protruding end 34) is configured to be within the recess 39 of the base member 44b. The end surface 34a of the protruding end 34 of the liner half 31 faces the surface 44a1 of the heating source 44a of the heater 40a with a distance Ds between them.

In such a heating, the recess 39 restrains air flow between the end surface 34a of the protruding end 34 and the surface 44a1 of the heating source 44a (opposing surfaces), while the heating source 44a heats and melts the melting allowance 35 of the protruding end 34.

### <Welding Between Liner Halves>

Next, the welding step of the liner halves 31 of the liner manufacturing member 60 is described.

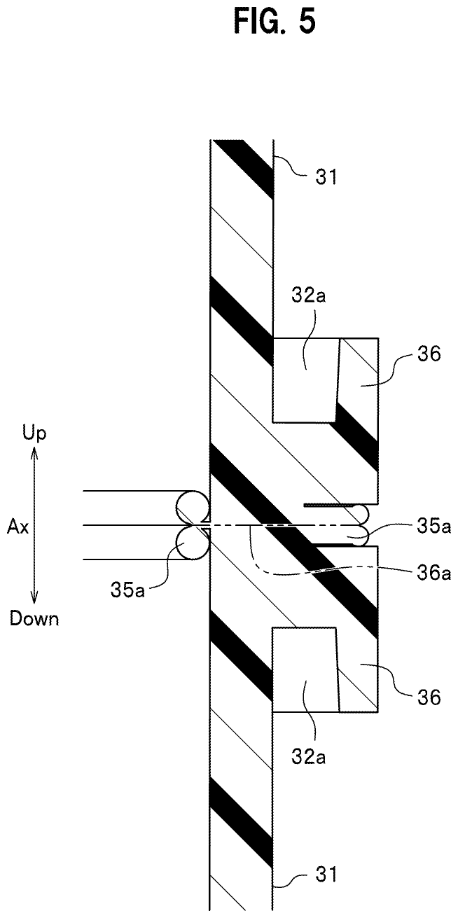

FIG. 5 illustrates the welding between the liner halves 31.

This welding step welds together an end of the upper liner half 31 and an end of the lower liner half 31, as shown in FIG. 5.

Specifically, in the welding, the liner halves 31 are pressed against each other by the support jig 46 shown in FIG. 4 with a predetermined load.

As shown in FIG. 5, this welding causes a molten material 35a of the melting allowance 35 (see FIG. 4) to flow in a direction that intersects a pressing direction (along the axial directions Ax) between the liner halves 31. This results in the molten materials 35a of the liner halves 31 to melt into each other at the welding surface 36a shown by the virtual line (double-dotted line in FIG. 5). And then, when the molten material 35a are cooled down, the liner halves 31 are united and connected to each other at the welding surface 36a.

In the above-described welding, the liner halves 31 may be vibrated by a vibrating device to accelerate the welding of the liner halves 31 when they are united at the welding surface 36a.

### <Cutting Step>

Next, the cutting step of the integrated liner halves 31 is described.

FIG. 6 is a illustration showing the cutting in which cutting is applied on the joint 36 between the liner halves 31 that are integrated in the welding.

As shown in FIG. 6, in this cutting, the flanges 32 (shown with the virtual line of two-dotted line) of the joint 36 are removed by cutting except their root portions 32c.

The root portions 32c being left are used to form the diameter-expanded portion 9 of the liner 2 described above. This completes a series of manufacturing steps for the liner 2 of the present embodiment (see FIG. 1).

The cap member 61 attached to the communication tube 17 of the liner 2 is removed from the communication tube 17 when the mouthpiece 3 is attached to the liner 2 (see FIG. 1).

### <<Effects>>

Next, description is given of effects provided by the manufacturing method of liner 2 and the liner manufacturing member 60 (member for manufacturing the high-pressure tank liner) used for this method according to the present embodiment.

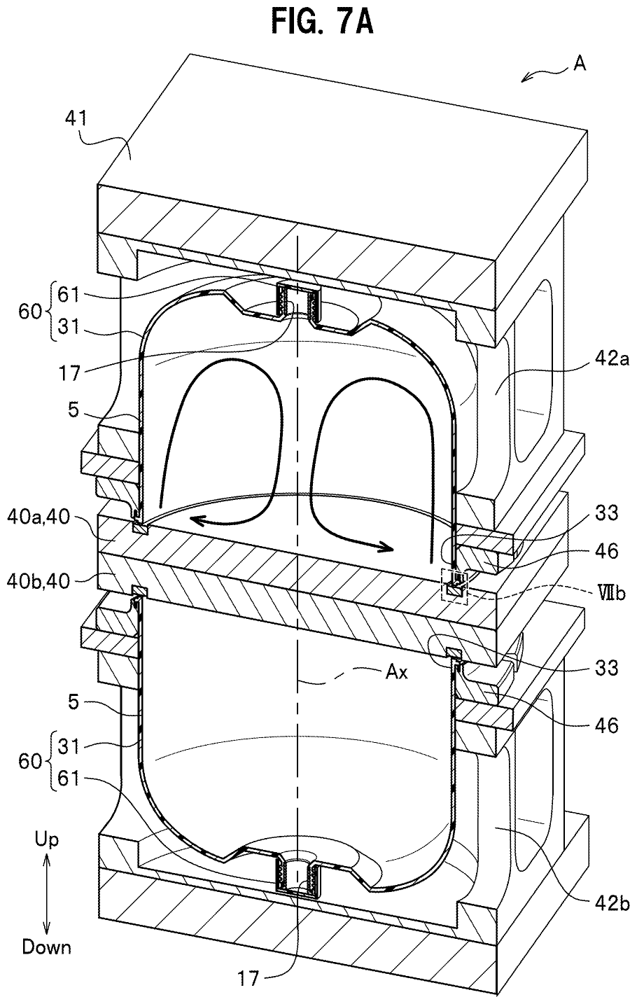

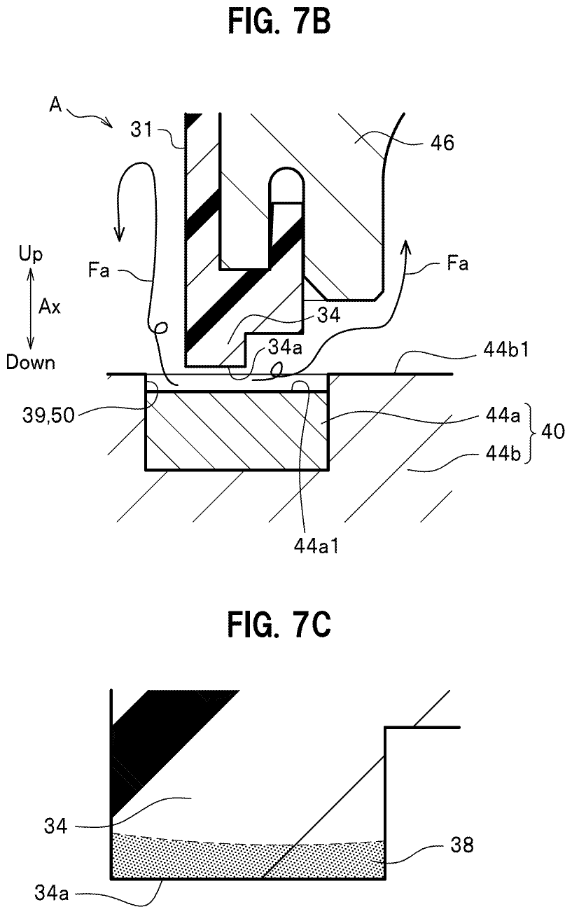

FIG. 7A is a schematic diagram showing a movement of airflow when the end of the liner half 31 of the liner manufacturing component 60 is heated. FIG. 7B is a partially enlarged cross-sectional view of the VIIb section of FIG. 7A. FIG. 7C is a schematic diagram showing a molten state of the end of the liner half 31.

FIG. 8A is a schematic diagram showing a movement of airflow when the end of the liner half 31 is heated in a conventional manufacturing method using a manufacturing device Ap. FIG. 8B is a partially enlarged cross-sectional view of the VIIIb section of FIG. 8A. FIG. 8C is a schematic diagram showing a molten state at the end of the liner half 31 in the VIIIb section of FIG. 8A. FIG. 8D is a partially enlarged cross-sectional view of the VIIId section of FIG. 8A. FIG. 8E is a schematic diagram showing a molten state at the end of the liner half 31 in the VIIId section of FIG. 8A.

First, here is a description given of the manufacturing method of the comparative example.

As shown in FIG. 8A, in the conventional manufacturing method using the manufacturing device Ap, the cap member 61 (FIG. 7A) is not attached to the communication tube 17 of the liner half 31, unlike the manufacturing method of the present embodiment.

As shown in FIG. 8A, in a heating step of the conventional manufacturing method, when the heater 40a heats the end of the upper liner half 31, an upward air flow Fb is generated by an air inside the warmed liner half 31. In other words, due to a chimney effect inside the liner half 31, air entering the inside of the liner half 31 from an outside through a gap between the lower end of the liner half 31 and the heater 40a escapes to the outside of the liner half 31 through the communication tube 17 without the cap member 61.

The above escaping of the air causes a portion heated by the heating source 44a in the outer circumference of the protruding end 34 (right side of the sheet of FIG. 8B) to be cooled by an outside air that is guided by the escaping air.

This results uneven forming of the molten portion 38 that is one-side distributed toward the outer circumference of the protruding end 34 (left side of the sheet in FIG. 8C), as shown shaded in FIG. 8C.

On the other hand, as shown in FIG. 8A, when the heater 40b heats the end of the lower liner half 31, an upward air flow Fb is also generated inside the lower liner half 31. In other words, air entering the inside of the liner half 31 from the outside through the communication tube 17 without the cap member 61 escapes to the outside of the liner half 31 through a gap between the upper end of the liner half 31 and the heater 40b.

The above escaping of the air causes a portion heated by the heating source 44a in the outer circumference of the protruding end 34 (left side of the sheet of FIG. 8D) to be cooled by the outside air that is guided by the escaping air, as shown in FIG. 8D.

This results uneven forming of the molten portion 38 of the protruding end 34 one-side distributed toward the inner circumference (right side of the sheet in FIG. 8E), as shown shaded in FIG. 8E.

In other words, the conventional manufacturing method causes uneven melting on the respective end surfaces 34a of the upper and lower liner halves 31, resulting in insufficient welding quality between the liner halves 31.

On contrast, in the manufacturing method of the liner 2 and the liner manufacturing member 60 (member for manufacturing a high pressure tank liner) used in this manufacturing method according to the present embodiment, the cap members 61 are attached to the respective communication tubes 17 of the upper and lower liner halves 31, as shown in FIG. 7A.

As shown in FIG. 7A, in the heating step of the manufacturing method according to the present embodiment, the cap member 61 attached to the communication tube 17 is able to prevent the rising air flow Fb from flowing up through the communication tube 17 outward of the liner half 31, when the heater 40a heats the end of the upper liner half 31. No rising airflow Fb occurs inside the liner half 31, but a convection flow C is generated.

As shown in FIG. 7B, in the heating step of this manufacturing method according to the present invention, an airflow suppression mechanism 50 including the recess 39 is used to suppress the upward airflow Fb (see FIG. 7B) that is about to flow from the outside of the liner half 31 (right side of the sheet in FIG. 7B) to the inside of the liner half 31 (left side of the sheet in FIG. 7B) between the surface 44a1 of the heating source 44a and the end surface 34a of the liner half 31 (protruding end 34).

The end surface 34a of the liner half 31 (protruding end 34) in this configuration is heated substantially evenly by the upward airflow Fa rising from the heating source 44a.

As a result, the molten portion 38 of the protruding end 34, indicated by shade in FIG. 7C, is formed substantially evenly across the protruding end 34 in a radial direction.

As shown in FIG. 7A, in the heating process of the manufacturing method of the present embodiment, when the heater 40b heats the end of the lower liner half 31, an inlet of the upward airflow Fb is blocked by the cap member 61 attached to the communication tube 17 (see FIG. 7A). This prevents more reliably the upward airflow Fb from occurring inside the liner half 31 in the present embodiment. As a result, the molten portion 38 of the protruding end 34, indicated by shade in FIG. 7C, is formed substantially evenly over the protruding end 34 in the radial direction.

This allows the manufacturing method and the liner manufacturing member 60 (member for manufacturing the high-pressure tank liner) used in this manufacturing method to produce the liner 2 (see FIG. 1) with good welding quality between liner halves 31, according to the present embodiment.

In the liner manufacturing member 60 (member for manufacturing the high-pressure tank liner) of the present embodiment, the cap member 61 has the peripheral wall 62 (protective portion) that covers to protect the O-ring contact surface 17b (seal member contact surface) formed on the communication tube 17 of the liner half 31.

The above liner manufacturing member 60 (member for manufacturing the high-pressure tank liner) and the liner 2 manufacturing method using the liner manufacturing member 60 is able to prevent the O-ring contact surface 17b from being scratched or stained until the liner 2 is obtained from the liner manufacturing member 60 and the mouthpiece 3 is attached to this liner 2.

In the liner manufacturing member 60 (member for manufacturing the high-pressure tank liner) of the present embodiment, the cap member 61 is formed of a bottomed cylindrical body that is externally fitted onto the communication tube 17 of the liner half 31.

Such a liner manufacturing member 60 (member for manufacturing the high-pressure tank liner) and the liner 2 manufacturing method using the liner manufacturing member 60 allows the liner half 31 to be easily attached to the communication tube 17.

According to such a liner manufacturing member 60 (member for manufacturing the high-pressure tank liner) and a method of manufacturing liner 2 using the liner manufacturing member 60, the communication tube 17 can be sealed more securely while reducing a wall thickness of the cap member 61.

In the manufacturing method and manufacturing device A of the liner 2 of the present embodiment, as shown in FIG. 4, the airflow suppression mechanism 50 provided with the recess 39 can be used to suppress the upward airflow Fb (see FIG. 8A) flowing from the outside of the liner half 31 (right side of the sheet in FIG. 4) into the inside of the liner half 31 (left side of the sheet in FIG. 4) between the surface 44a1 of the heating source 44a and the end surface 34a of the liner half 31 (protruding end 34).

The end surface 34a of the liner half 31 (protruding end 34) in the present embodiment is heated approximately evenly by the airflow Fa rising from the heating source 44a.

As a result, the molten portion 38 of the protruding end 34 indicated by shade in FIG. 7B is formed approximately evenly across the protruding end 34 in the radial direction.

This allows the manufacturing device A and manufacturing method of the present embodiment to obtain the liner 2 (see FIG. 1) with good welding quality between the liner halves 31.

In the manufacturing device A of the present embodiment, it is assumed that a width W1 of the heating source 44a is set to be at least three times a width W2 of the end surface 34a of the liner half 31 (protruding end 34).

The above manufacturing device A allows more uniform melting of the protruding end 34, leading further improvement in the welding quality between the liner halves 31.

In the manufacturing device A of the present embodiment, the distance (D2) between the end surface 34a of the liner half 31 (protruding end 34) and the surface 44b1 of the base member 44b is set at a value (D2=Ds−D1) obtained by subtracting the distance (D1) between the surface 44b1 of the base member 44b1 and the surface 44a1 of the heating source 44a from the distance (Ds) between the end surface 34a of the liner half 31 (protruding end 34) and the surface 44a1 of the heating source 44a as the design criterion.

According to such a manufacturing device A, because the surface 44a1 of the heating source 44a faces the end surface 34a of the liner half 31 (protruding end 34) at the distance (Ds) as a design criterion, the end surface 34a of the protruding end 34 is able to be melted in a stable manner.

Further, according to the manufacturing device A, the end surface 34a of the liner half 31 (protruding end 34) can be brought closer to the surface 44b1 of the base member 44b, depending on the depth (distance (D1)) of the recess 39 of the base member 44b. Specifically, the distance D2 between the end surface 34a of the protruding end 34 and the surface 44b1 of the base member 44b can be shorter than the distance Dp2 (see FIG. 8B) in the conventional manufacturing device Ap.

This further improves the airflow suppression effect of the airflow suppression mechanism 50, which includes the recesses 39, in this form of manufacturing device A.

The above is a description of the present embodiments. However, the present invention is not limited to the aforementioned embodiments, but can be implemented in various embodiments.

For example, the cap member 61 included in the liner manufacturing member 60 (see FIG. 3) of the above embodiment is assumed to be a bottomed cylindrical body made of an elastic member such as synthetic rubber. In other words, the cap member 61 of the above embodiment is assumed to be formed of a lid whose bottomed cylindrical body covers with its bottom the opening of the communication tube 17 from the outside.

However, a material and shape of the cap member 61 in the present invention is not limited to those described above, as long as air circulation into and out of the liner half 31 via the communication tube 17 is inhibited during the above-described heating step.

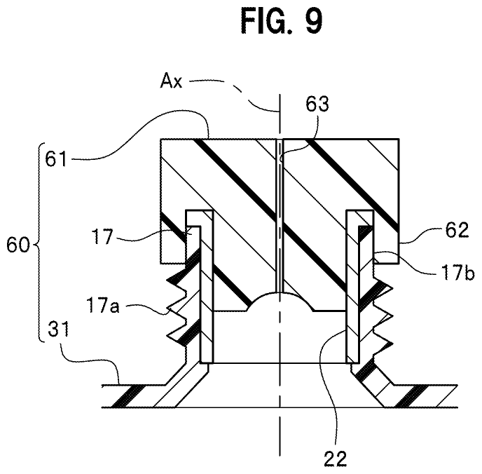

FIG. 9 is an illustration of a configuration of the liner manufacturing component 60 (member for manufacturing high-pressure tank liner) according to a modification of the present invention.

As shown in FIG. 9, the cap member 61 of the liner manufacturing member 60 according the a modification is provided with a cylindrical peripheral wall 62 (protective portion) that covers and protects the O-ring contact surface 17b (seal member contact surface) formed on the communication tube 17 and a cylindrical plug portion 63 that is fitted inside the communication tube 17.

The cap member 61 of the liner manufacturing member 60 according to the modification of the present invention allows a contact area of the cap member 61 with the communication tube 17 to be increased by the peripheral wall 62 and the plug portion 63, and thereby improving a holding force of the cap member 61 against the communication tube 17.

Further, the cap member 61 is attached to the communication tube 17 with the collar 22 attached as shown in FIG. 9, but can also be attached to the communication tube 17 without the collar 22.

Further, the cylindrical plug portion 63 of the cap member 61 has a pressure-release hole 63a formed therein. This pressure-release hole 63a is designed to release an internal pressure of the united liner halves 31 when the internal pressure increases in the welding step of the liner halves 31.

A material of this cap member 61 is assumed to be synthetic rubber, but is not limited to this type and can be an elastic porous material such as sponge. The cap member 61 made of such an elastic porous material can omit the pressure-release hole 63a.

Further, in the above embodiment, the surface 44a1 of the heating source 44a is set within the recess 39 that is recessed from the surface 44b1 of the base member 44b (see FIG. 4). However, the surface 44a1 of the heating source 44a can be flush with the surface 44b1 of the base member 44b. Such a heater 40 is easier to be produced.

### REFERENCE SIGNS LIST

1: High pressure tank
2: High pressure tank liner
3: Mouthpiece
3a: O-ring (seal member)
4: Fiber-reinforced resin layer
5: Body part
8: Major portion of body part
9: Diameter-expanded portion 9
17: Communication tube
17a: Threaded portion
17b: O-ring contact surface (seal member contact surface)
21: High pressure tank fill and drain hole
31: Liner half
32: Flange of liner half
33: Opening of liner half
34: Protruding end of liner half
34a: End surface of liner half (protruding end)
36: Joint between flange-to-flange (between liner halves)
38: Molten portion
39: Recess
40: Heater
40a: Heater
40b: Heater
44a: Heating source
44a1: Surface of heating source (surface facing end surface 34a of protruding end 34)
44b: Base member
44b1: Surface of base member
50: Airflow suppression mechanism
60: Liner manufacturing member (member for manufacturing high-pressure tank liner)
61: Cap member
62: Peripheral wall of cap member (protective portion)
63: Plug portion
63a: Pressure-release hole
A: High-pressure tank liner manufacturing device
Ax: Axis

1. A member for manufacturing a high-pressure tank liner that is produced by welding together a pair of liner halves having cylindrical bodies, the pair of liner halves being welded together to be to connected with each other on their one ends having openings,
the member comprising:
the liner half; and
a cap member that is easily attached to and removed from a communication tube of the liner half, the communication tube being formed on another end opposite to a joint portion on which the liner halves are connected with each other, and the communication tube communicating an inside and an outside of the high-pressure tank liner.

2. The member for manufacturing the high-pressure tank liner according to claim 1,
wherein
an outer peripheral surface of the communication tube includes a seal member contact surface formed thereon to be contacted by a seal member of a high-pressure tank having the high-pressure tank liner; and
the cap member includes a protective portion that covers and protects the seal member contact surface.

3. The member for manufacturing the high-pressure tank liner according to claim 2,
wherein
the cap member is formed mainly of a bottomed cylindrical body that is externally fitted onto the communication tube.

4. The member for manufacturing the high-pressure tank liner according to claim 1,
wherein
the cap member includes a plug portion fitted into the communication tube.

5. A method for manufacturing the high-pressure tank liner comprising:
preparing a pair of members for manufacturing the high-pressure tank liner according to claim 1;
heating and melting each of end surfaces having the openings of the pair of members for manufacturing the high-pressure tank liner with a preset heating source, the pair of members being placed to face each other at each of the openings of the liner halves; and
welding together the end surfaces of the liner halves melted to form the high-pressure tank liner.
